(19) United States
(12) Patent Application Publication
(10) Pub. No.: US 2020/0363845 A1
(43) Pub. Date: Nov. 19, 2020

(54) Display Arrangement and Thereto Related Integrated Circuit and Method and User Equipment

(71) Applicant: Huawei Technologies Co., Ltd., Shenzhen (CN)

(72) Inventor: Long Yang, Kista (SE)

(21) Appl. No.: 16/766,579

(22) PCT Filed: Nov. 24, 2017
(86) PCT No.: PCT/EP2017/080338

§ 371 Date: May 22, 2020

(51) Int. Cl. G06F 1/18

(52) U.S. Cl. CPC G06F 1/189; G06F 1/181

(57) ABSTRACT

A display arrangement and a method of manufacturing the display arrangement, where the display arrangement comprises a display, a flexible printed circuit (FPC), and a display integrated circuit (DIC), where the display comprises first electrical connectors. The DIC comprises second electrical connectors. The FPC comprises third electrical connectors. The DIC is arranged on the display with electrical connections between the first electrical connectors and the second electrical connectors, and the FPC is arranged on the DIC with electrical connections between the second electrical connectors and the third electrical connectors.

### TECHNICAL FIELD

The present disclosure relates to a display arrangement, to a display integrated circuit for driving a display, to a method of manufacturing a display arrangement for a user equipment, and to a user equipment comprising a display arrangement.

### BACKGROUND

A user equipment, such as mobile telephone, a tablet computer, or lap top computer, comprises a large display for providing visual information to a user of the user equipment. The display may be a so-called touch screen, via which a user of the user equipment may provide input to the user equipment in order to control the user equipment.

User equipment design is going towards displays, which cover a large portion of a body of the user equipment, such as in the case of mobile telephones. In some mobile telephones, substantially an entire face of the body of the telephone may be covered by the display. Such a mobile telephone may be referred to as a full screen phone.

The display of the user equipment is connected to a display integrated circuit (DIC). The DIC drives the display. The DIC is connected to the display, via inner leads. The DIC in turn, is connected to a control system of the user equipment via outer leads. The control system may comprise inter alia a microprocessor. The physical connection between the display and the DIC, as well as between the DIC and the control system may pose a problem, in particular, when the display covers a large portion of an entire face of a body of the user equipment.

The display comprises a conductive pattern arranged adjacent to a screen of the display, and configured for electrically connecting the display to components, such as the DIC.

The DIC may be a surface mounted component used in a chip on glass (COG) solution. In such a solution, the DIC is mounted on the display and electrically connected to the conductive pattern. Also, a flexible printed circuit (FPC) is mounted on the display and electrically connected to the conductive pattern. The FPC in turn, is electrically connected to the control system of the user equipment. Namely, the DIC connects to the FPC via the conductive pattern of the display in the COG solution. Accordingly, the COG solution requires a comparatively wide conductive pattern on the display. That is, the area of the conductive pattern takes up space on a face of a relevant user equipment, which space may not be utilised for presenting information on the screen of the display.

In a different solution, the display may comprise a narrower conductive pattern. In a so-called chip on flex (COF) solution, the DIC is mounted on and electrically connected to a flexible substrate. The flexible substrate in turn, is at one end mounted on the display and electrically connected to the conductive pattern, and at the other end directly, or indirectly e.g. via FPC, connected to the control system of the user equipment. Thus, the area of the interconnection border takes up less space on a face of a relevant user equipment then in the COG solution.

U.S. Pat. No. 6,738,030 discloses a display device using a COF and operating with a low driving voltage. The device comprises a display panel, a COF having a connection part on which the display panel is placed and a chip part on which a chip is placed.

A drawback with the COF solution is that it is more costly than the COG solution.

### SUMMARY

It would be advantageous to achieve a display arrangement overcoming, or at least alleviating, at least some of the above mentioned drawbacks.

It would be desirable to enable a display arrangement which provides for a large screen area on a user equipment at a low cost. Further, it would be desirable to provide for a method of manufacturing a display arrangement for a user equipment, which method provides for a large screen area at a low cost. Further, it would be desirable to provide a display integrated circuit (DIC) for driving a display, which DIC provides for a large screen area to be provided on a display arrangement at low cost. Further, it would be desirable to provide a user equipment having a large screen area provided at low cost.

To address one or more of these concerns, in individual independent claims there are defined, a display arrangement, a display integrated circuit, a method of manufacturing a display arrangement, and a user equipment comprising a display arrangement, respectively.

According to a first aspect of the disclosure, there is provided a display arrangement comprising a display, a flexible printed circuit (FPC), and a display integrated circuit (DIC) configured for driving the display. The display comprises first electrical connectors, the DIC comprises second electrical connectors, and the FPC comprises third electrical connectors.

The DIC is arranged on the display with electrical connections between the first electrical connectors and the second electrical connectors, wherein the FPC is arranged on the DIC with electrical connections between the second electrical connectors and the third electrical connectors. Since the DIC is arranged on the display and the FPC is arranged on the DIC, only the width of the DIC is required for connecting the DIC to the display while the FPC is available for connecting the display to a control system, e.g. of a user equipment. Since an FPC is used, the costlier COF solution is not required. As a result, a display arrangement having a large screen area at low cost is provided.

Herein, the term display relates to a display panel comprising a screen on which information may be presented, and one or more areas adjacent to the screen. The term screen, or screen area, of a display relates to the area of the display wherein pixels are arranged, which thus, permit information to be presented in the screen area. The one or more areas adjacent to the screen may be provided for other purposes than displaying information, such as for accommodating conductors and connectors, and/or for connecting the display to the DIC.

The display arrangement may be configured for forming part of a user equipment, such as e.g. a mobile phone, a tablet computer, a laptop computer, or similar.

According to embodiments of the first aspect, the second electrical connectors, may be arranged at a first outer surface of the DIC and at a second outer surface of the DIC, the second outer surface forming a surface opposite to the first outer surface. The second electrical connectors of the DIC at the second outer surface are arranged at the second outer surface by through silicon via TSV. In this manner, the second electrical connectors may be provided on to opposite outer surfaces of the DIC for bonding the DIC to display at the first outer surface, and to the FPC at the second outer surface.

According to embodiments of the first aspect, the FPC may extend from the DIC around an edge of the display to a side of the display opposite to a side where the DIC is arranged. In this manner, the FPC may be connected to a control system of the user equipment below the display. Thus, the display arrangement provides a small footprint, when installed in a user equipment.

According to embodiments of the first aspect, the second electrical connectors, may be arranged at a first outer surface of the DIC and at a second outer surface of the DIC, the second outer surface forming a surface opposite to the first outer surface. The second electrical connectors of the DIC arranged at the first outer surface may be second electrical connectors of a first electrical signal interface. The second electrical connectors of the DIC arranged at the second outer surface may be second electrical connectors of a second electrical signal interface. In this manner, two different electrical signal interfaces may be provided on to opposite outer surfaces of the DIC.

The first electrical signal interface may for instance comprise inner leads of the DIC. Thus, the first outer surface of the DIC may be configured for bonding to the display in order for the inner leads to be electrically connected to the display. The second electrical signal interface may for instance comprise outer leads of the DIC. Thus, the second outer surface of the DIC may be configured for bonding to the FPC in order for the outer leads to be electrically connect to the FPC.

According to embodiments of the first aspect, the display may comprise a first surface portion extending along an edge of the display. The first electrical connectors may be arranged at the first surface portion, and the DIC is arranged on the first surface portion. In this manner, the first surface portion may form of an electrical connection portion of the display. The first surface portion may be arranged between the screen area of the display and the said edge of the display. The first surface portion may be sufficiently wide for mounting and electrically connecting the DIC thereto.

According to a second aspect of the disclosure, there is provided a display integrated circuit (DIC) for driving a display of a user equipment. The DIC comprises a body, a processor circuit arranged inside the body, and electrical connectors, configured for electrically connecting the DIC with a display and with a further processor circuit. The body comprises a first outer surface, and a second outer surface opposite to the first outer surface. The electrical connectors, are arranged at the first outer surface and the second outer surface. The electrical connectors at the second outer surface are provided by through silicon via (TSV). The electrical connectors at the first outer surface are electrical connectors of a first electrical signal interface. The electrical connectors at the second outer surface are electrical connectors of a second electrical signal interface.

Since the electrical connectors are arranged at the first outer surface, since the electrical connectors are arranged at the second outer surface provided by TSV, since the electrical connectors at the first outer surface are electrical connectors of a first electrical signal interface, and since the electrical connectors at the second outer surface are electrical connectors of a second electrical signal interface, the DIC provides for being connected to a display via the first electrical signal interface at the first outer surface and to an FPC via the second electrical signal interface at the second outer surface. Thus, the DIC is connectable in a display arrangement, to a display at the first outer surface and to an FPC at the second outer surface. Accordingly, because the DIC may be utilised for connection to both the display and the FPC, the DIC enables a large screen area to be provided on a display arrangement at low cost, and accordingly, and also so in a user equipment.

The electrical connectors at the first and second outer surfaces may be second electrical connectors, as discussed above with reference to the display arrangement.

According to a third aspect of the disclosure, there is provided a method of manufacturing a display arrangement for a user equipment. The display arrangement comprises a display, a display integrated circuit (DIC) configured for driving the display, and a flexible printed circuit (FPC). The method comprises:

a first bonding step wherein the DIC is bonded to the display or the FPC, and

a second bonding step wherein the DIC is bonded to the other of the display and the FPC.

Since the DIC is bonded to the display, and the FPC is bonded to the DIC, only the width of the DIC is required for connecting the DIC to the display while the FPC is available for connecting the display to a control system, e.g. of a user equipment. Since an FPC is used, the costlier COF solution is not required. As a result, a method of manufacturing a display arrangement having a large screen area at low cost is provided.

Suitably, the DIC is a DIC according to aspects and/or embodiments discussed herein. Accordingly, the DIC may comprises a body with a first outer surface, and a second outer surface opposite to the first outer surface. Electrical connectors, are arranged at the first outer surface and the second outer surface.

According to embodiments of the third aspect, the first bonding step may comprise steps of:

supporting the display or the FPC on a stage,

positioning the DIC on the display or on the FPC, which is being supported on the stage in the step of supporting,

applying pressure to the DIC, and

applying heat. In this manner, the DIC may be bonded to the display or to the FPC in the first bonding step.

According to embodiments of the third aspect, the second bonding step comprises steps of:

supporting the display on a stage,

positioning the DIC on the display if the DIC was bonded to the FPC in the first bonding step, or

positioning the FPC on the DIC if the DIC was bonded to the display in the first bonding step, and

applying pressure to the FPC, and

applying heat. In this manner, the DIC may be bonded to the display, or to the FPC, in the second bonding step.

According to alternative embodiments of the third aspect, the second bonding step may comprise steps of:

supporting the FPC on a stage,

positioning the DIC on the FPC if the DIC was bonded to the display in the first bonding step, or

positioning the display on the DIC if the DIC was bonded to the FPC in the first bonding step, and

applying pressure to the display, and

applying heat. In this manner, the DIC may be bonded to the FPC, or to the display, in the second bonding step.

According to embodiments of the third aspect, a higher temperature may be applied in the step of applying heat of the first bonding step than in the step of applying heat of the second bonding step. In this manner, the bonding created in the first bonding step may not be unbonded in the second bonding step.

A bonding material utilised in the first bonding step may have a higher melting point than the bonding material utilised in the second bonding step.

According to embodiments of the third aspect, the display may comprise a first surface portion extending along an edge of the display. The DIC may be bonded to the first surface portion in the first bonding step if the DIC is bonded to the display in the first bonding step, or bonded to the first surface portion in the second bonding step if the DIC is bonded to the display in the second bonding step. In this manner, the first surface portion may form an electrical connection portion of the display, to which the DIC is bonded. Again, the first surface portion may be arranged between the screen area of the display and the said edge of the display. The first surface portion may be sufficiently wide for mounting and electrically connecting the DIC thereto.

According to embodiments of the third aspect, in at least one of the first bonding step and the second bonding step an anisotropic conductive film ACF may be utilised. In this manner, electrical connections may be provided between conductors of the display and conductors of the DIC, and/or between conductors of the DIC and the FPC.

According to a fourth aspect of the disclosure, there is provided a user equipment comprising a display arrangement according to any one of aspects and/or embodiments discussed herein. In this manner, there is provided a user equipment having a large screen area at low cost.

According to embodiments of the fourth aspect, the display of the display arrangement may cover at least 80% of an entire face of the user equipment. In this manner, a user equipment having a large display may be provided, such as e.g. in a full screen phone.

In particular, a large screen area of the display may be provided in the user equipment.

Further features of, and advantages with, the disclosure will become apparent when studying the appended claims and the following detailed description.

### BRIEF DESCRIPTION OF THE DRAWINGS

Various aspects and/or embodiments of the disclosure, including its particular features and advantages, will be readily understood from the example embodiments discussed in the following detailed description and the accompanying drawings, in which:

FIGS. 1a-1c illustrate a display arrangement according to embodiments, and components of a display arrangement,

FIGS. 2a-2c illustrate different views of a display integrated circuit (DIC) according to embodiments,

FIG. 3 illustrates a user equipment according to embodiments,

FIG. 4 illustrates embodiments of a method of manufacturing a display arrangement for a user equipment, and

FIGS. 5a-5c, and 6a-6c illustrate embodiments of methods of manufacturing a display arrangement for a user equipment.

### DETAILED DESCRIPTION

Aspects and/or embodiments of the disclosure will now be described more fully. Like numbers refer to like elements throughout. Well-known functions or constructions will not necessarily be described in detail for brevity and/or clarity.

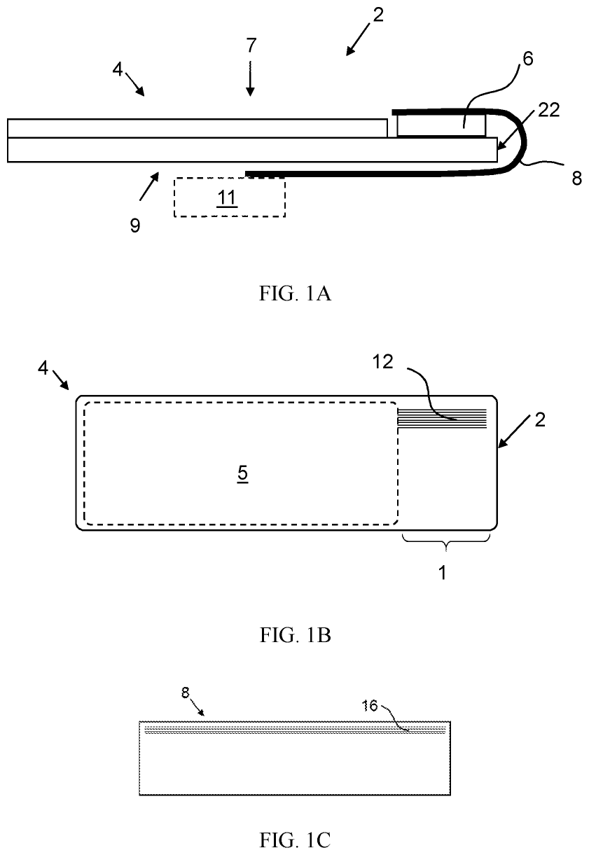

FIGS. 1a-1c illustrate a display arrangement 2 according to embodiments, and components thereof. FIG. 1a illustrates a side view of the display arrangement 2. The display arrangement 2 comprises a display 4, a flexible printed circuit (FPC) 8, and a display integrated circuit (DIC) 6. FIG. 1b illustrates a top view of the display 4 of the display arrangement 2. FIG. 1c illustrates a view of the FPC 8.

In FIG. 1a the display 4 is shown comprising a first layer 3, and a second layer 3′. However, the display 4 may alternatively comprise only one layer, or more than two layers. The first layer 3 may for instance comprise a thin-film-transistor (TFT) LCD glass panel, and the second layer 3′may for instance comprise a colour filter and/or encapsulation glass.

The DIC 6 is configured for driving the display 4. The display 4 may comprise e.g. LCD, LED, or OLED. The DIC 6 provides an interface function between a control system 11 and the display 4. The DIC 6 may comprise e.g. a microcontroller and a memory.

The control system 11 may be a control system 11 of a user equipment, such as e.g. a mobile phone, a tablet computer, a laptop computer, or similar. The control system 11 may comprise at least a microprocessor, a microcontroller, an ASIC, or similar component. The control system 11 of a user equipment is schematically indicated with broken lines in FIG. 1a. The FPC 8 may for instance be connected to the control system 11 via one or more non-shown connectors.

The display 4 comprises first electrical connectors 12, see FIG. 1b. In FIG. 1b only a limited number of the first electrical connectors 12 are shown. The first electrical connectors 12 are connected with, and are configured for supplying electrical signals to, electrical components arranged in a screen area 5 of the display 4. The electrical components in the screen area 5 are configured to form pixels of the screen area 5. Collectively, or in groups, the pixels form information displayed in the screen area 5 by means of the electrical signals sent via the first electrical connectors 12.

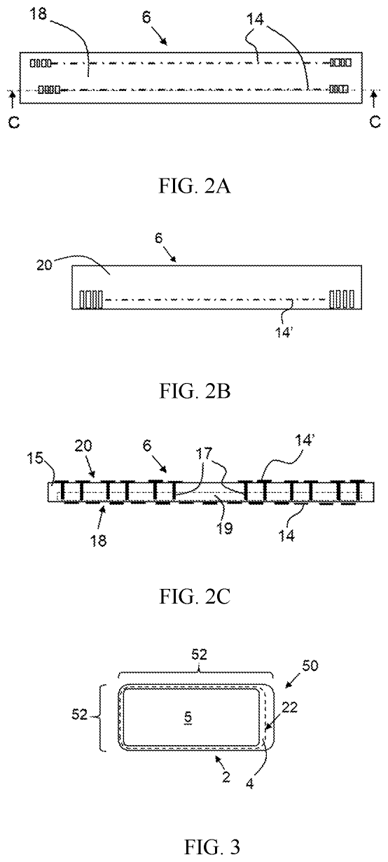

The DIC 6 comprises second electrical connectors, see below with reference to FIGS. 2a-2c. The FPC 8 comprises third electrical connectors 16. See FIG. 1c in which the FPC 8 is shown in a straightened manner. Namely, the FPC 8 comprise as a flexible substrate and is thus, bendable as shown in the side view of FIG. 1a. In FIG. 1c only a limited number of the third electrical connectors 16 are shown. The third electrical connectors 16 are configured for supplying electrical signals to the DIC 6.

In order to facilitate illustrating the different components and their arrangement, the proportions of the different components in FIGS. 1a-1c deviate from the proportions of a display device in practice. Mentioned purely as an example, the width of the DIC 6 in the side view of FIG. 1a may be within a range of 1-3 mm.

The DIC 6 is arranged on the display 4 with electrical connections between the first electrical connectors 12 and the second electrical connectors of the DIC 6, and the FPC 8 is arranged on the DIC 6 with electrical connections between the second electrical connectors of the DIC 6 and the third electrical connectors 16.

The arrangement of the DIC 6 on the display 4, and with the FPC 8 on the DIC 6 provides for a narrow connection of the DIC 6 and the FPC 8 along an itch 22 of the display 4. Thus, a large portion of the display may be taking up of the area five. Accordingly, information may be presented over a large portion of the display 4.

More specifically, the display 4 comprises a first surface portion 10 extending along an edge 22 of the display 4. The first surface portion 10 is arranged between the screen area 5 of the display 4 and the edge 22. The first electrical connectors 12 of the display 4 are arranged at the first surface portion 10. Thus, the first surface portion 10 may be said to form of an electrical connection portion of the display 4. The DIC 6 is arranged on the first surface portion 10. The DIC 6 is mounted on and electrically connected to the display 4 at the first surface portion 10. Electrical contact is provided between the first electrical connectors 2 of the display 4 and the second electrical connectors of the DIC 6.

When mounted in a user equipment, the FPC 8 extends from the DIC 6 around the edge 22 of the display 4 to a second side 9 of the display 4 opposite to a first side 7 of the display 4 where the DIC 6 is arranged, i.e. as illustrated in FIG. 1a. Thus, the display arrangement 2 leaves a small footprint in the user equipment. On the second side 9 of the display 4 a control system 11 of the user equipment may be arranged.

FIGS. 2a-2c illustrate different views of a display integrated circuit (DIC) 6. The DIC 6 is configured for driving a display of a user equipment. The DIC 6 may be a DIC 6 forming part of a display arrangement 2 as discussed above with reference to FIGS. 1a-1c.

The DIC 6 comprises a body 15. The body 15 comprises a first outer surface 18 and a second outer surface 20 opposite to the first outer surface 18. The DIC 6 further comprises a processor circuit 19 arranged inside the body 15 and electrical connectors 14, 14′. The processor circuit 19 is indicated with broken lines in FIG. 2c. The electrical connectors 14, 14′ are in the following referred to as second electrical connectors 14, 14′, such that their function in the display arrangement 4 discussed herein is clearly understood.

The second electrical connectors 14, 14′ are configured for electrically connecting the DIC 6 with a display 4 and with a further processor circuit. The further processor circuit may form part of a control system of a user equipment.

The second electrical connectors 14, 14′ are arranged at the first outer surface 18 and the second outer surface 20. FIG. 2a shows a bottom view of the DIC 6 with second electrical connectors 14 arranged in two lines. The second electrical connectors 14 at the first outer surface 18 are second electrical connectors 14 of a first electrical signal interface. FIG. 2b shows a top view of the DIC 6 with second electrical connectors 14′ arranged in one line. The second electrical connectors 14′ at the second outer surface 20 are second electrical connectors 14′ of a second electrical signal interface.

The second electrical connectors 14′ of the second electrical signal interface are provided at the second outer surface 20 by through silicon via (TSV). Thus, the electrical connectors, usually only provided on one side of an integrated circuit, may be provided at two opposite sides of the DIC 6. The TSV is a vertical interconnect access (VIA) that passes through a silicon wafer or die of the DIC 6. For the purpose of illustrating the TSV, FIG. 2c shows a rough schematic cross section through the DIC 6 along line C-C in FIG. 2a. Reference number 17 indicates TSV filled with conductive material extending from electrical components/circuits inside the body 15 to the second electrical connectors 14′ of the second electrical signal interface arranged at the second outer surface 20.

Accordingly, the DIC 6 is configured for being connected to a display via the second electrical connectors 14 of the first electrical signal interface at the first outer surface 18.

Moreover, the DIC 6 is configured for being connected to an FPC via the second electrical connectors 14′ of the second electrical signal interface at the second outer surface 20. More specifically, the second electrical connectors 14 of the first electrical signal interface are configured for being connected to the first electrical connectors 12 of the display 4, see FIG. 1a, and the second electrical connectors 14′ of the second electrical signal interface are configured for being connected to the third electrical connectors 16 of the FPC 8, see FIG. 1c.

FIG. 3 illustrates a user equipment 50 according to embodiments. The user equipment 50 may for instance be a mobile telephone. The user equipment comprises a display arrangement 2 according to any one of aspects and/or embodiments discussed herein. For instance, the user equipment 50 may comprise a display arrangement 2 in accordance with the embodiments discussed in connection with FIGS. 1a-2c.

A display 4 of the display arrangement 2 is indicated with broken lines in FIG. 3. Outer edges of the display 4 may be covered by a housing of the user equipment 50 and may thus, not be visible unless the user equipment is disassembled. The edge 22 discussed above with reference to FIGS. 1 and 1b is indicated in FIG. 3. A screen area 5 of the display 4, visible during use of the user equipment 50 is indicated with a full line in FIG. 3.

The display 4 of the display arrangement 2 may cover at least 80% of an entire face 52 of the user equipment 50. According to some embodiments, the display 4 may cover at least 90% of the entire face 52 of the user equipment 50.

More specifically, the screen area 5 of the display 4 may cover at least 80% of an entire face 52 of the user equipment 50. According to some embodiments, the screen area 5 may cover at least 90% of the entire face 52 of the user equipment 50.

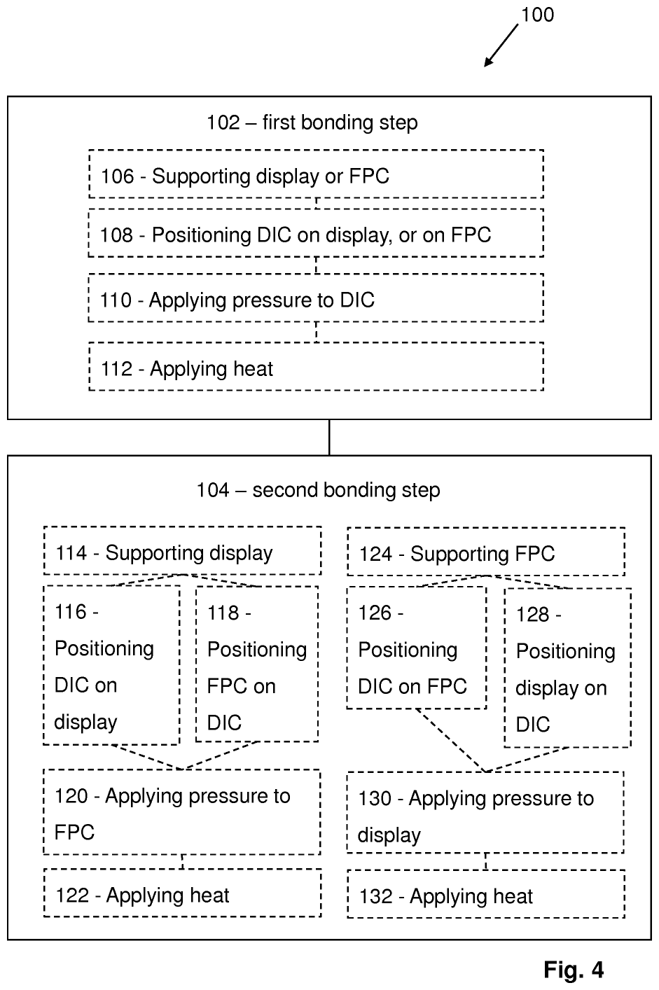

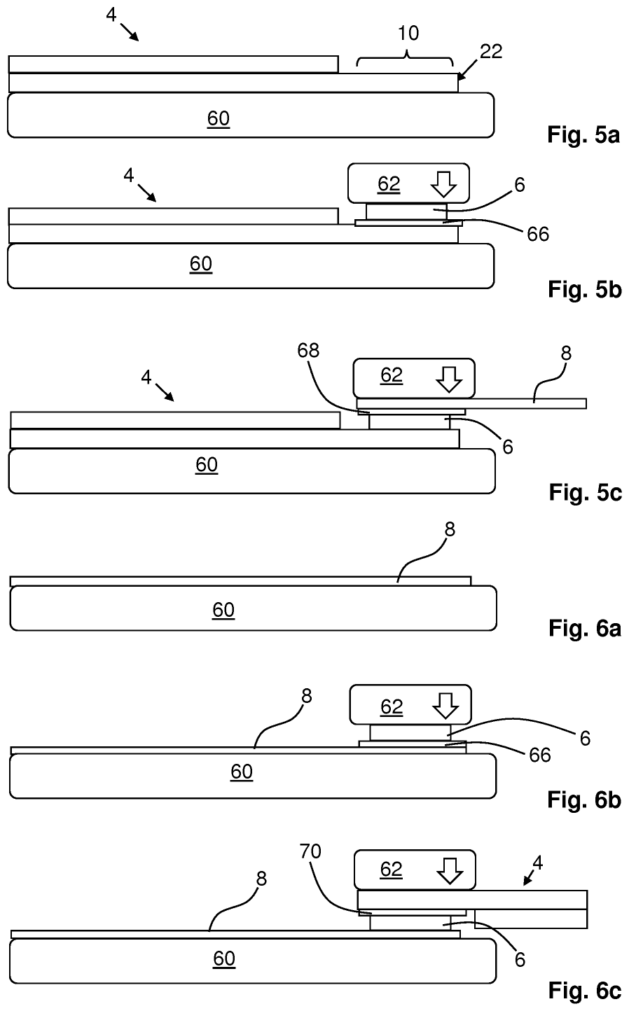

FIG. 4 illustrates a method 100 of manufacturing a display arrangement for a user equipment. The method 100 will be discussed in the following with reference to FIG. 4, as well as with reference to FIGS. 5a-5c, and 6a-6c.

The display arrangement may be a display arrangement according to any one of aspects and/or embodiments discussed herein. For instance, the display arrangement may be a display arrangement 2 in accordance with the embodiments discussed in connection with FIGS. 1a-2c. The user equipment may be a user equipment according to any one of aspects and/or embodiments discussed herein. The user equipment may be a user equipment 50 in accordance with the embodiments discussed in connection with FIG. 3.

Accordingly, the display arrangement 2 comprises a display 4, a display integrated circuit (DIC) 6 configured for driving the display 4, and a flexible printed circuit (FPC) 8.

The method 100 comprises:

a first bonding step 102 wherein the DIC 6 is bonded to the display 4 or the FPC 8, and

a second bonding step 104 wherein the DIC 6 is bonded to the other of the display 4 and the FPC 8.

The first and second bonding steps 102, 104 may be performed simultaneously, or in sequence.

The essence of the first bonding step 102 is shown in FIGS. 5b and 6b. In the embodiment of FIG. 5b, the DIC 6 is bonded to the display 4 in the first bonding step 102. In the embodiment of FIG. 6b, the DIC 6 is bonded to the FPC 8 in the first bonding step 102. The essence of the second bonding step 104 is shown in FIGS. 5c and 6c. In the embodiment of FIG. 5c, the DIC 6 is bonded to the FPC 8 in the second bonding step 104. In the embodiment of FIG. 6c, the DIC 6 is bonded to the display 4 in the second bonding step 104.

If the first and second bonding steps 102, 104 are performed simultaneously, such embodiments may be said to be illustrated by FIGS. 5c and 6c.

The first bonding step 102 may comprises steps of:

Supporting 106 the display 4 or the FPC 8 on a stage 60. Embodiments of the step of supporting 106 are shown in FIGS. 5a and 6a. In the embodiment of FIG. 5a, the display 4 is supported on a stage 60. In the embodiment of FIG. 6a, the FPC 8 is supported on a stage 60.

Positioning the DIC 108 on the display 4 or on the FPC 8, which is being supported on the stage in the step of supporting 106.

Applying pressure 110 to the DIC 6.

Applying heat 112.

In the steps of applying pressure 110 and applying heat 112a head 62 may be utilised. The steps of applying pressure 110 and applying heat 112 may be performed at least partially simultaneously. The steps of applying pressure 110 and applying heat 112 are shown in FIGS. 5b and 6b.

Suitably, a bonding material 66 which melts during the step of apply heat 112 is arranged between the DIC 6 and the display 4, or between the DIC 6 and the FPC 8, respectively, in the first bonding step 102.

According to embodiments shown in FIG. 5c, the second bonding step 104 may comprise steps of:

Supporting the display 114 on a stage 60.

Positioning the DIC 116 on the display 4 if the DIC 6 was bonded to the FPC 8 in the first bonding step 102, or

positioning the FPC 118 on the DIC 6 if the DIC 6 was bonded to the display 4 in the first bonding step 102.

Applying pressure 120 to the FPC 8.

Applying heat 122.

In the steps of applying pressure 120 and applying heat 122 a head 62 may be utilised. The steps of applying pressure 120 and applying heat 122 may be performed at least partially simultaneously. In FIG. 5c a bonding material 68 which melts during the step of applying heat 122 is shown between the DIC 6 and the FPC 8. This applies when the step of positioning the FPC 118 on the DIC 6 is performed. Naturally, if instead the step of positioning the DIC 116 is performed, a bonding material which melts during the step of applying heat 122 is arranged between the display 4 and the DIC 6.

According to embodiments shown in FIG. 6c, the second bonding step 104 may comprise steps of:

Supporting the FPC 124 on a stage 60.

Positioning the DIC 126 on the FPC 8 if the DIC 6 was bonded to the display 4 in the first bonding step 102, or

positioning the display 128 on the DIC 6 if the DIC 6 was bonded to the FPC 8 in the first bonding step 102.

Applying pressure 130 to the display 4, and

Applying heat 132.

In the steps of applying pressure 130 and applying heat 132 a head 62 may be utilised. The steps of applying pressure 130 and applying heat 132 may be performed at least partially simultaneously. In FIG. 6c a bonding material 70 which melts during the step of applying heat 132 is shown between the display 4 and the DIC 6. This applies when the step of positioning the display 128 on the DIC 6 is performed. Naturally, if instead the step of positioning the DIC 126 on the FPC 8 is performed, a bonding material which melts during the step of applying heat 132 is arranged between the DIC 6 and the FPC 8.

The stage 60 forms a support during the steps related to applying pressure and applying heat. Heat may be applied from the stage 60, or via the stage 60, during the steps of applying heat. The same stage 60 may be utilised during the different steps of applying pressure and applying heat. Alternatively, different stages 60 may be utilised in the different steps of applying pressure and applying heat.

The head 62 forms a movable device utilised during the steps related to applying pressure and applying heat. Thus, in order to position relevant components on the stage 60, the head 62 is moved away from the stage 60. In order to apply pressure, the head 62 is moved towards the relevant components as indicated by the arrows in FIGS. 5b, 5c, 6b, 6c. Heat may be applied from the head 62, or via the head 62, during the steps of applying heat. The same head 62 may be utilised during the different steps of applying pressure and applying heat. Alternatively, different heads 62 may be utilised in the different steps of applying pressure and applying heat.

The bonding materials 66 utilised in the first bonding step 102 may have a higher melting point than the bonding materials 68, 70 utilised in the second bonding step 104.

Accordingly, a higher temperature may be applied in the step of applying heat 112 of the first bonding step 102 than in the step of applying heat 122, 132 of the second bonding step 104.

In this manner, the bonding created in the first bonding step 102 is be unbonded in the second bonding step 104.

In at least one of the first bonding step 102 and the second bonding step 104 an anisotropic conductive film (ACF) may be utilised. Accordingly, one or both of the bonding materials 66, 68, 70 may comprise an ACF. When the bonded, an ACF provides electrical connections between the first, second, and third electrical conductors 12, 14, 16. ACF may be have different melting points. Accordingly, the bonding materials 66, 68, 70 may have different melting points.

In FIG. 5a the first surface portion 10 extending along an edge 22 of the display 4, discussed above with reference to FIGS. 1a and 1b, is indicated. The DIC 6 may be bonded to the first surface portion 10 in the first bonding step 102 if the DIC 6 is bonded to the display 4 in the first bonding step 102, or bonded to the first surface portion 10 in the second bonding step 104 if the DIC 6 is bonded to the display 4 in the second bonding step 104.

It is to be understood that the foregoing is illustrative of various example embodiments and that the scope of protection is defined only by the appended claims. A person skilled in the art will realize that the example embodiments may be modified, and that different features of the example embodiments may be combined to create embodiments other than those described herein.

1.-13. (canceled)

14. A user equipment (UE) comprising:
a display arrangement comprising:
a display comprising first electrical connectors;
a display integrated circuit (DIC) comprising second electrical connectors and configured to operate the display, wherein the DIC is arranged on the display, wherein the second electrical connectors comprise a first portion and a second portion, and wherein the first portion of the second electrical connectors is configured to connect to the first electrical connectors through first electrical connections; and
a flexible printed circuit (FPC) comprising third electrical connectors, wherein the FPC is arranged on the DIC, and wherein the third electrical connectors are configured to connect to the second portion of the second electrical connectors through second electrical connections.

15. The UE of claim 14, wherein the display covers at least 80% of an entire face surface of the UE.

16. The UE of claim 14, wherein the DIC further comprises a first outer surface and a second outer surface, wherein the second outer surface is opposite to the first outer surface, wherein the first portion of the second electrical connectors are arranged at the first outer surface, wherein the second portion of the second electrical connectors are arranged at the second outer surface, and wherein the second portion of the second electrical connectors is arranged at the second outer surface by through silicon via (TSV).

17. The UE of claim 14, wherein the FPC extends from the DIC around an edge of the display to a first side of the display, wherein the first side is opposite to a second side of the display, and wherein the DIC is arranged at the second side.

18. The UE of claim 14, wherein the DIC further comprises a first outer surface and a second outer surface, wherein the second outer surface is opposite to the first outer surface, wherein the first portion of the second electrical connectors are arranged at the first outer surface, wherein the second portion of the second electrical connectors are arranged at the second outer surface, wherein the first portion of the second electrical connectors are of a first electrical signal interface, and wherein the second portion of the second electrical connectors are of a second electrical signal interface.

19. The UE of claim 14, wherein the display further comprises a first surface portion extending along an edge of the display, wherein the first electrical connectors are arranged at the first surface portion, and wherein the DIC is arranged on the first surface portion.

20. The UE of claim 14, wherein the DIC is bonded to the display or the FPC, and wherein the DIC is bonded to the other of the display and the FPC that is not bonded.

21. The UE of claim 20, wherein the display or the FPC is supported on a stage, wherein the DIC is positioned on the display or on the FPC that is supported on the stage, wherein first pressure is applied to the DIC, wherein first heat is applied to the DIC and the display, wherein the display is supported on a second stage,
wherein the DIC is positioned on the display when the DIC is bonded to the FPC;
wherein the FPC is positioned on the DIC when the DIC is bonded to the display,
wherein second pressure is applied to the FPC, and
wherein second heat is applied to the DIC and the FPC.

22. A display arrangement comprising:
a display comprising first electrical connectors;
a display integrated circuit (DIC) comprising second electrical connectors and configured to operate the display, wherein the DIC is arranged on the display, wherein the second electrical connectors comprise a first portion and a second portion, wherein the first portion is configured to connect to the first electrical connectors through; and
a flexible printed circuit (FPC) comprising third electrical connectors, wherein the FPC is arranged on the DIC , and wherein the third electrical connectors are configured to connect to the second portion of the second electrical connectors through the third electrical connectors.

23. The display arrangement of claim 22, wherein the DIC further comprises a first outer surface and a second outer surface, wherein the second outer surface is opposite to the first outer surface, wherein the first portion of the second electrical connectors are arranged at the first outer surface, wherein the second portion of the second electrical connectors are arranged at the second outer surface, and wherein the second portion of the second electrical connectors are arranged at the second outer surface by through silicon via (TSV).

24. The display arrangement of claim 22, wherein the FPC extends from the DIC around an edge of the display to a first side of the display, wherein the first side is opposite to a second side, and wherein the DIC is arranged in the second side.

25. The display arrangement of claim 22, wherein the DIC further comprises a first outer surface and a second outer surface, wherein the second outer surface is opposite to the first outer surface, wherein the first portion of the second electrical connectors are arranged at the first outer surface, wherein the second portion of the second electrical connectors are arranged at the second outer surface, wherein the first portion of the second electrical connectors are of a first electrical signal interface, and wherein the second portion of the second electrical connectors are of a second electrical signal interface.

26. The display arrangement of claim 22, wherein the display further comprises a first surface portion extending along an edge of the display, wherein the first electrical connectors are arranged at the first surface portion, and wherein the DIC is arranged on the first surface portion.

27. A method of manufacturing a display arrangement for a user equipment (UE) comprising:
a first bonding step bonding a display integrated circuit (DIC) to a display or a flexible printed circuit (FPC), wherein the DIC is configured to operate the display; and
a second bonding step bonding the DIC to the other of the display and the FPC that is not bonded during the first bonding step.

28. The method of claim 27, wherein the first bonding step comprises:
supporting the display on a stage;
positioning the DIC on the display or on the FPC while the display is being supported on the stage;
applying pressure to the DIC; and
applying heat to the DIC and the display.

29. The method of claim 27, wherein the second bonding step comprises:
supporting the display on a stage;
positioning the DIC on the display when the DIC is bonded to the FPC in the first bonding step; positioning the FPC on the DIC when the DIC is bonded to the display in the first bonding step;
applying pressure to the FPC; and
applying heat to the DIC and FPC.

30. The method of claim 27, wherein the second bonding step comprises:
supporting the FPC on a stage;
positioning the DIC on the FPC when the DIC is bonded to the display in the first bonding step;
positioning the display on the DIC when the DIC is bonded to the FPC in the first bonding step;
applying pressure to the display; and
applying heat to the DIC and the display.

31. The method of claim 27, wherein the first bonding step comprises applying a first heat, wherein the second bonding step comprises applying a second heat, and wherein the first heat is at a higher temperature than the second heat.

32. The method of claim 27, further comprises:
bonding the DIC to a first surface portion of the display in the first bonding step when the DIC is bonded to the display in the first bonding step, wherein the first surface portion extends along an edge of the display; and
bonding the DIC to the first surface portion in the second bonding step when the DIC is bonded to the display in the second bonding step.

33. The method of claim 27, further comprising utilizing an anisotropic conductive film (ACF) in at least one of the first bonding step or the second bonding step.
